(19) United States
(12) Patent Application Publication
(10) Pub. No.: US 2022/0193919 A1
(43) Pub. Date: Jun. 23, 2022

(54) 3D POSITION AND ORIENTATION CALCULATION AND ROBOTIC APPLICATION STRUCTURE USING INERTIAL MEASURING UNIT (IMU) AND STRING-ENCODER POSITIONS SENSORS

(71) Applicant: JEANOLOGIA TEKNOLOJI A.S., Cigli, Izmir (TR)

(72) Inventor: Merih OZCELIK, Cigli, Izmir (TR)

(21) Appl. No.: 17/599,877

(22) PCT Filed: Mar. 26, 2020
(86) PCT No.: PCT/TR2020/050244

§ 371 Date: Sep. 29, 2021

(30) Foreign Application Priority Data
Apr. 5, 2019 (TR) 2019/05154

(51) Int. Cl. B25J 13/08; B25J 9/00; B25J 9/16; B25J 11/00; B25J 19/02

(52) U.S. Cl. CPC B25J 13/089; B25J 9/0078; B25J 19/02; B25J 9/1653; B25J 11/008; B25J 9/1692

(57) ABSTRACT

A 3D position and orientation calculation and robotic application structure using an inertial measuring unit and string—encoder positions sensors.

### TECHNICAL FIELD

The invention relates to 3D position and orientation calculation and robotic application structure using inertial measuring unit (IMU) and string—encoder positions sensors.

### BACKGROUND OF THE INVENTION

Operators who repeat the same job constantly cannot always achieve the same qualities, no matter how skilled they are. In addition, different operators cannot produce the same products, even though they try to do. Because, very small defects or differences are often missed by the manual workers. Also, when it comes to the jobs that could be dangerous for human health, such as bleaching operations that uses potassium permanganate in textile finishing. These human deficiencies must be eliminated to improve the quality and reproducibility of the job.

Industrial robots have been a part of industrial production for a long time rather than handwork, and they are expanding their sphere of influence with developing technologies. Robots offer high reproducibility, reliability, repeatability and they are fatigue-proof, therefore a subjective influence on the tasks can be excluded. The process capability can be increased, and a permanent quality can be provided. The use of robots requires the teaching of tasks to robots.

Much prior work has focused on providing the robot with knowledge of the task either through demonstration or by teaching. For this teaching procedure, it is necessary to record the operator's movements in high precision and accuracy.

There are few different methods for robot programming. The most common method is to program a robot by a teach pendant. Teach pendant is a human machine interface (HMI) device which is connected to robot by a cable for on-site monitoring the state of the robot. While programming a robot by a teach pendant, the operator must enter each target points, commands, functions, speeds, motion modes etc. manually. This method is an easy and fast method for jobs such as welding, where only a few specific points are taught to robots. But for jobs that include continuous paths, such as human hand movement, need another robot programming method. The most common way for this kind of jobs is to use a 3D position and orientation tracking systems to continuously record points in 3D space. Afterwards, the recorded movement data is somehow transferred to a robot to perform same movements.

Tracking systems are used for estimating the position and orientation of moving objects. There are various types of tracking systems and they can be classified according to the measuring principle and used technology such as optical, acoustic, micro electro-mechanical systems (MEMS), radio frequency, electromagnetic and mechanical. These systems have different specifications such as accuracy, precision, cost, working range, calibration procedure, external susceptibility etc. Appropriate system should be selected according to the requirements. The most accurate systems are laser tracking systems, but they are very expensive, sensitive to the external factors and they need much time for the calibration procedure.

Electromagnetic based tracking systems are sensitive to the magnetic field distortion, so they are not suitable for use where metallic or conductive objects exist. Vision-based tracking systems have good accuracy, but they can easily affect from the environmental conditions, such as dirt, water, changes of intensity of light, reflection or they can suffer from occlusion.

String-encoder based tracking systems provide a high accuracy and noise-free outputs, do not need precise linear guidance and are ideal for wet, dirty, or outdoor environments and applications where measuring range travels over tough environments. Besides this, these systems are low-cost and portable.

However, dimension deviations due to manufacturing tolerances, string-length uncertainties, or string looseness could cause unacceptable performance of these systems. Also, if the number of string-encoders increases, string tension could be very high on the movable object where the strings are attached. Therefore, it could be hard to use the system at high speeds. In literature, there are various applications where string-encoders were used.

A MEMS inertial measurement unit (IMU) can be used to track the position and orientation of an object. The IMU unit usually consists of triaxial accelerometers and triaxial gyroscopes, and sometimes accompanied by a triaxial magnetometers to increase the accuracy of device. Accelerometers measure linear acceleration where gyroscopes measure angular velocity and magnetometers measure magnetic flux density in three mutually orthogonal directions.

Based on these sensor readings, values of Euler angles (roll, pitch, and yaw) are calculated to find position and orientation of the IMU on its own coordinate frame. IMU is low cost, lightweight, portable, miniaturized device but is not suitable for continuous tracking of an object for a long period because the position and orientation error increases over time quickly.

The underlying reason for this is; single integration of angular velocity measurements and double integration of acceleration measurements is required to calculate position and orientation. The integration of noisy acceleration and angular velocity measurements, obtained from IMU, leads to increased error.

IMU errors are classified into two categories; systematic errors and random errors. Systematic errors are permanent, but it is possible to eliminate and calibrate them with the use of specialized equipment. The most common systematic errors are; constant bias, scale factor error, scale factor sign asymmetry, dead zone, non-orthogonality error and misalignment error. On the other hand, random errors are based on the sensors unpredictability and have much more effect on the results and they cannot be eliminated completely. The most common random errors are; bias stability, scale factor instability and white noise.

IMU can also be affected from mechanical vibrations and magnetic interferences. To leave behind these problems and create more accurate systems, IMUs are usually combined with other sensors.

Hybrid systems, which consists of an IMU and a position sensor are used in a wide range of applications to find the position and orientation of objects with better accuracy. Position sensor which is combined with an IMU can be an ultrasonic position sensor, a vision-based position sensor or an optical position sensor. But all these position sensors have shortcomings such as line-of sight requirements, reflection and occlusion issues or relatively high price.

There are many papers about hybrid systems that combine IMU and string-encoders. Usually, one IMU is used to find the orientation and a few string-encoders are used to find the position of moving objects.

String-encoder position sensor is a device used to measure linear position (and sometimes velocity) using a flexible cable, spring-loaded spool and an optical encoder.

Sensor's body is mounted to a fixed surface and stainless-steel string is attached to a movable object. As the object moves, sensor produces an electrical signal proportional to the string's linear extension. This signal is processed by a microcontroller and sent to a PC via an interface which will be explained later. 3D position and even orientation could be calculated by using a few of these sensors.

After finding linear measurements of all strings on the system, some techniques must be used to calculate position and orientation of the movable object. There are techniques that called law of cosines, multilateration, trilateration and triangulation which are able to determine the relative position between points by using the geometry of triangles or tetrahedra. The law of cosines is useful for computing the third side of a triangle when two sides and their enclosed angle are known, and in computing the angles of a triangle if all three sides are known.

In the literature US patent application numbered US2018345490 relates “A robot system includes a robot controller, a teach pendant including an orthogonal jog operation section, and an information display device. The robot controller sets positions on a robot coordinate system through which a hand tip section of a robot can pass as sampling points, and notifies the information display device of the positions of the sampling points and determination result information of whether or not the sampling points are within a range of motion of the hand tip section, and whether or not the sampling points are in the vicinity of a singularity. The information display device generates a graphical image that visually distinguishes the portion of the range of motion of the hand tip section, the portion near the singularities, etc., using the positions of the sampling points and the determination result information, and overlays the graphical image on an image of the robot.”

In the mentioned application, a robotic system that performs a teaching process by programming with the teach pendant is disclosed.

In the literature US patent application numbered US2019022858 relates “A robot configured to provide accurate control over the rate of spin or rotation of the robot. To control the rate of spin, the robot includes an inertia shifting (or moving) assembly positioned within the robot's body so that the robot can land on a surface with a target orientation and “stick the landing” of a gymnastic maneuver. The inertia shifting assembly includes sensors that allow the distance from the landing surface (or height) to be determined and that allow other parameters useful in controlling the robot to be calculated such as present orientation. In one embodiment, the sensors include an inertial measurement unit (IMU) and a laser range finder, and a controller processes their outputs to estimate orientation and angular velocity. The controller selects the right point of the flight to operate a drive mechanism in the inertia shifting assembly to achieve a targeted orientation.”

In the said application, a robot system including inertial measurement unit and laser range finder is disclosed.

In the literature US patent application numbered US2003178964 relates “The present invention discloses a robotic manipulator, comprising at least one joint, each joint having a drive axis and at least one microelectromechanical system (MEMS) inertial sensor aligned with at least one drive axis providing sensing of a relative position of the drive axis. The robotic manipulator can include an inertial measurement unit (IMU) coupled to the robotic manipulator for determining the end effector position and orientation. A controller can be used, receiving a signal from at least one MEMS inertial sensor and controlling at least one joint drive axis in response to the signal to change the relative position of the joint drive axis. Rate information from MEMS sensors can be integrated to determine the position of their respective drive axes.”

In the said application, a robot control system including MEMS and IMU is described.

Due to the above-mentioned disadvantages there was a need to introduce a new 3D position and orientation calculation and robotic application structure.

### DISCLOSURE OF THE INVENTION

Based on this position of the technique, the object of the invention is to provide a new 3D position and orientation calculation and robotic application structure that eliminates existing disadvantages.

Another object of the invention is to provide a structure that allows calculating the position and orientation of the recording apparatus in three dimensions.

Another object of the invention is to provide a structure that best meets the expectations of accuracy and precision with minimum error.

Another object of the invention is to provide a structure that provides ease of calculation and high accuracy.

Another object of the invention is to create a structure that will protect human health and prevent occupational diseases by making use of potassium permanganate in textile finishing, not through human, to robots.

Another object of the invention is to provide a structure that enables production with the same quality and standard in repetitive works.

Another object of the invention is to provide a structure that allows both the recording device and the robot to be operated simultaneously and the recording obtained with the recording device can be repeated by the robot at a later time.

Another object of the invention is to eliminate the disadvantages caused by the sensors affected by magnetic field by creating a structure that can work in places where metallic or conductive objects are located.

Another object of the invention is to provide a structure capable of recording the movements of the operator with high precision and accuracy.

### EXPLANATION OF THE FIGURES

FIG. 1 A representative view of the 3D position and orientation calculation and robotic application structure according to the invention

FIG. 2 A representative view of the arrangement of the string—encoder position sensors in the 3D position and orientation calculation and robotic application structure according to the invention.

FIG. 3 A representative view of the portable recording apparatus in the 3D position and orientation calculation and robotic application structure according to the invention

### REFERENCE NUMBERS

A—3D Position and Orientation Calculation and Robotic Application Structure
B—String Encoder Position Sensors
1—Movement Record Cabinet
2—Application Cabinet
3—Object to Apply
4—Portable Recording Apparatus
4.1 Front End
4.2 Rear End
5—Robot
6—Wire
7—String Encoder First Position Sensor
8—String Encoder Second Position Sensor
9—String Encoder Third Position Sensor
10—String Encoder Fourth Position Sensor
11—String Encoder Fifth Position Sensor
12—String Encoder Sixth Position Sensor
13—Wire Drawing Mechanism
14—Inertial Measuring Unit (IMU)
15—Laser Pointer
16—Incremental Encoder

### DETAILED DESCRIPTION OF THE INVENTION

In this detailed explanation, the innovation of the invention is explained only with examples that will have no limiting effect on better understanding of the subject.

The invention is a three-dimensional position and orientation calculation and robotic application structure (A), which is designed to meet the expectations of accuracy and precision in the best way and with minimum error, which allows the application of at least one object to apply (3) at the same quality and standard at all times in repetitive works characterized in that; comprises, a movement recording cabinet (1) in which the successive movements of the users to the said object to apply (3) are recorded by means of at least one portable recording apparatus (4), the application cabinet (2) where the movements recorded in the said movement recording cabinet (1) are applied exactly, the robot (5) which is located in said application cabinet (2) and enables the unmanned application to the object to apply (3) by applying the recorded movements of said portable recording apparatus (4) exactly, string—encoder position sensors (B) positioned within said movement recording cabinet (1) to detect the x, y and z positions of said portable recording apparatus (4) and inertial measurement unit (14) positioned on said portable recording apparatus (4) and measuring the angular velocity and acceleration values of said portable recording apparatus (4).

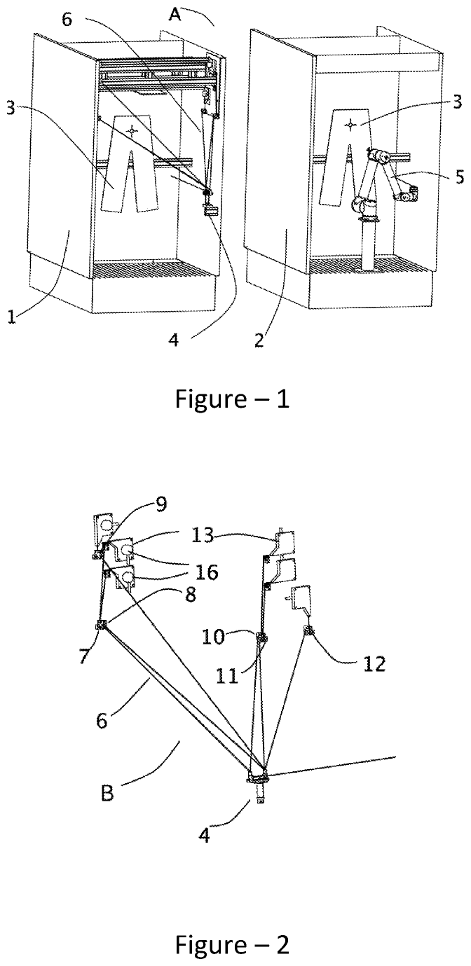

FIG. 1 shows a representative view of the 3D position and orientation calculation and robotic application structure (A) according to the invention.

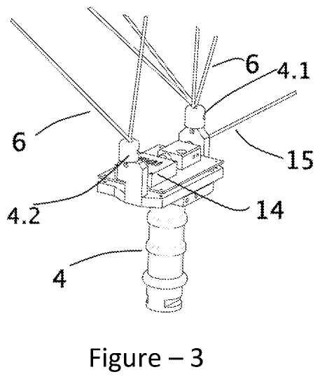

FIG. 2 shows a representative view of the arrangement of the string—encoder position sensors (B) in the 3D position and orientation calculation and robotic application structure (A) according to the invention.

FIG. 3 shows a representative view of the portable recording apparatus (4) in the 3D position and orientation calculation and robotic application structure (A) according to the invention.

The three-dimensional position and orientation calculation and robotic application structure (A) of the invention consists main parts of; a movement recording cabinet (1) in which the successive movements of the users to the said object to apply (3) are recorded by means of at least one portable recording apparatus (4), the application cabinet (2) where the movements recorded in the said movement recording cabinet (1) are applied exactly, the robot (5) which is located in said application cabinet (2) and enables the unmanned application to the object to apply (3) by applying the recorded movements of said portable recording apparatus (4) exactly, string—encoder position sensors (B) positioned within said movement recording cabinet (1) to detect the x, y and z positions of said portable recording apparatus (4), the wire (6) determining the position of said portable recording apparatus (4) by determining the instantaneous length value by positioning between said portable recording apparatus (4) and said string—encoder position sensors (B), the string—encoder first position sensor (7), positioned on one of said string—encoder position sensors (B), on a wall of said movement recording cabinet (1) and fixed at the rear end (4.2) of said portable recording apparatus (4), the string—encoder second position sensor (8), which is located on the wall of said movement recording cabinet (1) and fixed at a front end (4.1) of said portable recording apparatus (4), as another of said string—encoder position sensors (B), the string—encoder third position sensor (9) positioned on the wall of said movement recording cabinet (1) and fixed to a point on the front end (4.1) of said portable recording apparatus (4), as another of said string—encoder position sensors (B), the string—encoder fourth position sensor (10) positioned as one of said string—encoder position sensors (B) on the wall of said movement recording cabinet (1) and fixed at a point on the rear end (4.2) of said portable recording apparatus (4), the string—encoder fifth position sensor (11), which is located on the wall of said movement recording cabinet (1) and fixed to a point on the front end (4.1) of said portable recording apparatus (4), as another of said string—encoder position sensors (B), the string—encoder sixth position sensor (12), which is positioned on the wall of said movement recording cabinet (1) and fixed at a front end (4.1) of said portable recording apparatus (4), as another of said string—encoder position sensors (B), the wire drawing mechanism (13) which exerts a force to carry the portable recording apparatus (4) by means of the rollers in it, performing the pulling function of said wire (6), inertial measurement unit (14) positioned on said portable recording apparatus (4) and measuring the angular velocity and acceleration values of said portable recording apparatus (4), laser pointer (15) positioned on said portable recording apparatus (4) and incremental encoder (16) forming the sensor portion of said string—encoder position sensors (B).

The three-dimensional position and orientation calculation and robotic application structure (A) which is the subject of the invention generally consists of the movement recording cabinet (1) and the application cabinet (2). Said movement recording cabin (1) is the cabin where the portable recording apparatus (4) used by the operator is located and the motion recording operation is performed.

The other cabinet, the application cabinet (2), is the cabin where the robot (5) is located and the movements recorded in the movement recording cabinet (1) are played.

Said movement recording cabinet (1) has string—encoder position sensors (B) built in to perform motion recording. This structure consists of an inertial measurement unit (14) fixed to the portable recording apparatus (4) and 6 string—encoder position sensors (7,8,9,10,11,12) placed in the cabinet and placed at a certain distance from each other.

Of the said string—encoder position sensors (B), the second string—encoder position sensor (8), the third string—encoder position sensor (9), the fifth string—encoder position sensor (11) and the sixth string—encoder position sensor (12), the portable recording apparatus (4) the first string—encoder position sensor (7) and the fourth string—encoder position sensor (10), the other two of which are fixed at the front end (4.1), are fixed to a point at the back end (4.2) of the portable recording apparatus (4).

To calculate the x, y, z positions of the said portable recording apparatus (4), the information is used that received from second string—encoder position sensor (8), third string—encoder position sensor (9), fifth string—encoder position sensor (11) and the string—encoder position sensor (12) fixed to the front end (4.1) of the said portable recording apparatus (4).

The information received from the first string—encoder position sensor (7) and the fourth string—encoder position sensor (10) fixed to said back end (4.2) and second string—encoder position sensor (8) and fifth string—encoder position sensor (11) fixed from and the front end (4.1) of the portable recording apparatus (4) is combined to the angle of inclination from the inertial measurement unit (14) and used to calculate the yawing angle, which is the angle of rotation around the z axis of the portable recording apparatus (4). Cosine law is used in all of these positions and orientation calculations.

There is a UR10 series robot (5) from Universal Robot inside the said application cabinet (2). Said robot (5) is mounted on a fixed metal stand, which is robust enough not to vibrate during the inertia movements of the robot. This robot (5) fulfills the task of playing and repeating motion records obtained in the movement recording cabinet (1) and stored in the computer. A laser module is attached to the center point of the end function of said robot (5) and is used to compare the direction of the robot (5) and portable recording apparatus (4) and to monitor the accuracy of the work done.

ADIS16480 MEMS IMU was chosen for this system as the mentioned inertial measurement unit (14). The ADIS16480, the inertial measurement unit (14), is a complete inertial system that includes a three-axis gyroscope, a three-axis accelerometer, a three-axis magnetometer, pressure sensor, and an expanded Kalman filter (EKF) for dynamic orientation detection.

Said IMU (14) has a dynamic accuracy of 0.3 degrees for rolling and inclination angles and 0.5 degrees for the wobble angle. As a result of the tests, it is seen that ADIS16480 has a dynamic accuracy of approximately 1 degree for the angle of inclination and inclination, but there is no clear situation for the wobble angle. Some dynamic motion tests in ADIS16480 show that the wobble angle error can reach 10 degrees within 30 seconds. Even if ADIS16480 is kept constant, the error is growing rapidly.

The yaw angle has the problem of random walking and variable deviation stability. For these reasons, the rolling angle and tilt angle outputs of the ADIS16480 are used in the present invention, but the wobble angle output is not used.

Said string—encoder position sensors (B) are used for one-dimensional displacement measurements in most industrial applications. Said string—encoder position sensors (B) can be combined with a correct configuration and used to calculate the position and even orientation of a moving object. The best known feature of the string—encoder position sensors (B) is its high stability and quiet measuring ability. These features enable us to create a high accuracy system.

In the three-dimensional position and orientation calculation and robotic application structure (A) of the invention, the string—encoder position sensors (B) are six. Said string—encoder position sensors (B) have two parts called wire drawing mechanism (13) and incremental encoder (16).

The wire drawing mechanism (13) of said string—encoder position sensors (B) is selected as SICK-PFG13-A1CM0544 and the incremental encoder (16) is SICK-DFS60B-S1AC04096.

The measuring range of said wire drawing mechanism (13) is 0 to 5 m with repeatability of <=0.5 mm. The maximum working speed is 4 m/s and the maximum wire (6) acceleration is 4 m/s2 of the wire drawing mechanism (13).

The incremental encoder (16) produces 4096 pulses per revolution and has a resolution of 0.09 mm with these sensors selected. The maximum output frequency of said string—encoder position sensors (B) is 600 kHz.

Said string—encoder position sensors (7,8,9,10,11,12) for forming triangles between said string—encoder position sensors (7,8,9,10,11,12) and portable recording apparatus (4), is mounted in certain positions on the movement recording cabinet (1) and six wire (6) ends are attached to the portable recording apparatus (4).

Said triangles are used in the calculation of positions and angle of wobble. The x, y, z coordinates of the origin points of the string—encoder position sensors (7,8,9,10,11,12) on the movement recording cabinet (1) are as follows;

| | |
|---|---|
| the string - encoder first position sensor (7) | (0,0,0) |
| the string - encoder second position sensor (8) | (0,0,0) |
| the string - encoder third position sensor (9) | (0,0,434) |
| the string - encoder fourth position sensor (10) | (0,1378,0) |
| the string - encoder fifth position sensor (11) | (0,1378,0) |
| the string - encoder sixth position sensor (12) | (−400,1378,0) |

The string—encoder position sensors (7,8,9,10,11,12) help the operator carry the weight of the portable recording apparatus (4). This is because the string—encoder position sensors (7,8,9,10,11,12) bodies are mounted at higher points than the operation area of the portable recording apparatus (4). For this reason, the rollers inside the wire drawing mechanism (13) exert a force to carry the portable recording apparatus (4). On the other hand, this power can worsen the response of the portable recording apparatus (4) at high speeds, but does not affect the system of the invention, since the said system will be used for jobs such as painting and spraying that do not require high speed.

UR10, which is used as the robot (5) mentioned in the subject matter of the invention, is a 6-DOF serial robot consisting of six rotary joints. Each joint is driven separately by a motor and each has a ±360 rotation range and a speed limit of 120-180°/s.

In trigonometry, the cosine law is used for the following situations in a non-perpendicular triangle:
If the length of the two edges and the angle between these edges are known, the length of the third edge can be calculated,
If the length of all three sides is known, all the inside angles of the triangle can be calculated.

The following figure can help to visualize the cosine law. In an ABC triangle, a, b and c are the lengths of a triangle, and α, β and γ are the angles opposite these edges, respectively.

If this formula is rearranged to calculate the angle instead of an edge length,

$$γ = {cos}^{- 1} ( \frac{{a}^{2} + {b}^{2} - {c}^{2}}{2 a b} ) \qquad ( Y )$$

In the said application, triangles with known edge lengths were obtained using measurements taken from the string—encoder position sensors (7,8,9,10,11,12). In these triangles, the desired calculations are made using the law of cosine and equations (X) and (Y).

In the three-dimensional position and orientation calculation and robotic application structure (A) of the invention, there are two controller cards. The first one is on the portable recording apparatus (4) and is called the orientation card.

There are one ADIS16480 IMU (14), one microprocessor, one USB port and various electronic components on the board. The main purpose of this card is the IMU (14) and Serial Peripheral Interface (SPI) to power the ADIS16480 IMU (14), read the rolling and tilt angle values, and transmit these readings to the personal computer (PC) via the Universal Serial Bus (USB). communication through the protocol. All the necessary pin connections of the IMU (14) are made on this card.

The second controller card works as a data acquisition card. The data acquisition card contains one microcontroller, six 8-pin female connectors, six buffer amplifiers, one USB port, 16 pin input-output sockets and various electronic components. Each string—encoder sensor (7,8,9,10,11,12) generates an electrical signal in proportion to its wire length. This signal is transferred to the controller board via an 8-pin connector (one for each encoder). These signals are processed in the buffer amplifier and sent to the microcontroller. The microcontroller then transmits these signals to the PC via the USB port.

The data collected from the controller card is transferred to the computer via USB ports. The PC runs a program written in Pascal programming language using Delphi integrated development environment (IDE). This program calculates the x, y, z position, rolling, inclination and wobble angles of the portable recording apparatus (4) during motion recording, records at a frequency of 100 Hz and sends these calculated values to the robot (5). Thus, the recorded movements can be repeated at any time by the robot (5). For this, rolling and slope angle values are read from the orientation card. In addition, the cosine law is applied using the wire length values taken from the data acquisition card and x, y, z positions and the angle of wobbling are calculated with the designed program. All these calculated values are rearranged in a form using the built-in functions and variables of URScript and transferred to the robot (5) controller (URControl) at a frequency of 40 Hz.

The program also has an interface to interact with the operator and display information about the system, such as the real time position of the portable recording apparatus (4), the initial parameters of the string—encoder position sensors (B), and the IMU (14).

In addition, the operator can control the robot (5) from the interface using the “Play, Pause, Stop” buttons.

First of all, the string—encoder position sensors (B) consist of incremental encoders (16) and start to count from scratch due to the nature of the encoders. Therefore, the portable recording apparatus (4) is fixed to a known place called the starting reference position and energizing of the string—encoder position sensors (B) is performed while the portable recording apparatus (4) is in this position. When the portable recording apparatus (4) is in the starting reference position, the lengths of the wire (6) of the string—encoder position sensors (B) are measured manually and these data are entered into the PC program.

After the energization process is completed, the program automatically starts the calculation of the x, y and z positions and the yaw angle. After that, motion recording can be started by pressing the “Start Recording” button in the PC program.

The following steps are applied to calculate the x, y, z positions of the said portable recording apparatus (4).

1) Two points must be selected in the movement recording cabinet (1). The first point can be arbitrarily selected. However, the second point should be selected from a different point than the first on the observed axis, while the other two axes should be selected at the same point. If the x-axis is to the observed axis and the first point (x=0, y=0, z=0) is selected, the second point (x=a, y=0, z=0) is selected and the variable “a” value is any value selected. These points are defined as sensor connection points and guidance components are mounted on these points. The fixed distance between the sensor connection points is measured.

2) The wires (6) coming out of the two sensor connection points are fixed to the same point in front of the portable recording apparatus (4).

3) A triangle with three side lengths was obtained. The distances between the two sensor ports are known (fixed), the distances between the sensor ports and the portable recording apparatus (4) are also known (string—encoder position sensors (B) are read). Now, the cosine law can be applied to this triangle.

4) The position of the portable recording apparatus (4) on the observed axis is calculated according to the formula below.

Above said triangle, the front end (4.1) is the point of the portable recording apparatus (4) of the TTF second string—encoder position sensor (8), third string—encoder position sensor (9), fifth string—encoder position sensor (11) and sixth string—encoder position sensor (12). “X” length is the distance to be calculated. The length “c” is the distance between the fifth string—encoder position sensor (11) and the sixth string—encoder position sensor (12), and this length is fixed to 400 mm. The lengths “a” and “b” are read from the fifth string—encoder position sensor (11) and the sixth string—encoder position sensor (12). Using the cosine formula, the cosine law can be applied in the triangle S5TTFS6 and the cos α can be calculated. In the TTFS5B triangle, the length x can be calculated using the following equation.

x=cos α*b

The y and z axis position calculations are done in the same way as the above rules. In the Y axis position calculation, the measurements of the second string—encoder position sensor (8) and the fifth string—encoder position sensor (11) are used. In the Z-axis position calculation, the measurements of the second string—encoder position sensor (8) and third string—encoder position sensor (9) are used.

The calculation of the yaw angle is done as follows. While the portable recording apparatus (4) is stationary, the IMU (14) measurements must be constant. However, as explained earlier, it is not possible to take fixed measurements from the IMU (14) by nature. In particular, the wobble angle is very noisy because the z axis is parallel to the gravity vector. The roll and tilt angle measurements of the IMU (14) always have better precision than the roll angle measurement. To increase system accuracy, the roll angle measurement is calculated with string—encoder position sensors (B) as described below.

The TTB is the junction at the rear end (4.2) of the portable recording apparatus (4) of the first string—encoder position sensor (7) and the string—encoder position sensor (10). It is calculated by the Y position of the TTF is calculated using the second string—encoder position sensor (8) and the fifth string—encoder position sensor (11), and the y position of the TTB using the first string—encoder position sensor (7) and the fourth string—encoder position sensor (10). The dy length is the difference between these two calculations. a is a fixed length of 123.5 mm. The yaw angle can be calculated using the formula below.

$$ψ = arcsin ( \frac{d y}{a * cos β} ) * \frac{180}{π}$$

β the angle of inclination of the movement recording apparatus (4).

Unlike the wobble angle output of the IMU (14), this solution provides stable and accurate results without any noise and error buildup.

Rolling and inclination angles are read directly from ADIS16480 IMU (14) at a frequency of 40 Hz. The yaw angle values are also read from the IMU 14 for comparison with the calculated yaw angle, but the yaw angle output of the IMU 14 is not used by the system due to relatively high errors. The internal EKF of ADIS16480 is enabled for better orientation estimates. It was observed that the wobble angle output of the EKF had noticeably late response times when the magnetometer was activated. To prevent this problem, the magnetometer is disabled.

1. A three-dimensional position and orientation calculation and robotic application structure, which is designed to meet the expectations of accuracy and precision in the best way and with minimum error, which allows the application of at least one object to apply at the same quality and standard at all times in repetitive works characterized in that it comprises a movement recording cabinet in which successive movements of users to the said object to apply are recorded by means of at least one portable recording apparatus, an application cabinet where the movements recorded in the said movement recording cabinet are applied exactly, a robot which is located in said application cabinet and enables unmanned application to the object to apply by applying the recorded movements of said portable recording apparatus exactly, string—encoder position sensors positioned within said movement recording cabinet to detect x, y and z positions of said portable recording apparatus and an inertial measurement unit positioned on said portable recording apparatus and measuring angular velocity and acceleration values of said portable recording apparatus.

2. The three-dimensional position and orientation calculation and robotic application structure according to claim 1, comprising a wire determining the position of said portable recording apparatus by determining an instantaneous length value by positioning between said portable recording apparatus and said string—encoder position sensors.

3. The three-dimensional position and orientation calculation and robotic application structure according to claim 1, comprising a string—encoder first position sensor, positioned on one of said string—encoder position sensors, on a wall of said movement recording cabinet and fixed at a rear end of said portable recording apparatus.

4. The three-dimensional position and orientation calculation and robotic application structure according to claim 3, comprising a string—encoder second position sensor, which is located on the wall of said movement recording cabinet and fixed at a front end of said portable recording apparatus, as another of said string—encoder position sensors.

5. The three-dimensional position and orientation calculation and robotic application structure according to claim 4, comprising a string—encoder third position sensor positioned on the wall of said movement recording cabinet and fixed to a point on the front end of said portable recording apparatus, as another of said string—encoder position sensors.

6. The three-dimensional position and orientation calculation and robotic application structure according to claim 5, comprising a string—encoder fourth position sensor positioned as one of said string—encoder position sensors on the wall of said movement recording cabinet and fixed at a point on the rear end of said portable recording apparatus.

7. The three-dimensional position and orientation calculation and robotic application structure according to claim 6, comprising a the string—encoder fifth position sensor, which is located on the wall of said movement recording cabinet and fixed to a point on the front end of said portable recording apparatus, as another of said string—encoder position sensors.

8. The three-dimensional position and orientation calculation and robotic application structure according to claim 7, comprising a the string—encoder sixth position sensor, which is positioned on the wall of said movement recording cabinet and fixed at a front end of said portable recording apparatus, as another of said string—encoder position sensors.

9. The three-dimensional position and orientation calculation and robotic application structure (A) according to claim 1, comprising a wire drawing mechanism which exerts a force to carry the portable recording apparatus by means of rollers in it, performing the pulling function of said wire.

10. The three-dimensional position and orientation calculation and robotic application structure according to claim 1, comprising an incremental encoder forming the sensor portion of said string—encoder position sensors.

11. The three-dimensional position and orientation calculation and robotic application structure according to claim 8, wherein said string—encoder apparatus comprises the second string—encoder position sensor, the third string—encoder position sensor, the fifth string—encoder position sensor and the sixth string—encoder position sensor is used to calculate the x, y, z positions.

12. The three-dimensional position and orientation calculation and robotic application structure according to claim 1, wherein said inertial measurement unit comprises a three-axis gyroscope, a three-axis accelerometer, a three-axis magnetometer, pressure sensor and an expanded Kalman filter (EKF) for dynamic orientation detection.

13. The three-dimensional position and orientation calculation and robotic application structure according to claim 3, wherein said fixed string—encoder first position sensor is positioned at the point (0,0,0) as the x, y, z coordinates.

14. The three-dimensional position and orientation calculation and robotic application structure according to claim 4, wherein said fixed string—encoder second position sensor is positioned at the point (0,0,0) as the x, y, z coordinates.

15. The three-dimensional position and orientation calculation and robotic application structure according to claim 5, wherein said fixed string—encoder third position sensor is positioned at the point (0,0,434) as the x, y, z coordinates.

16. The three-dimensional position and orientation calculation and robotic application structure according to claim 6, wherein said fixed string—encoder fourth position sensor is positioned at the point (0, 1378,0) as the x, y, z coordinates.

17. The three-dimensional position and orientation calculation and robotic application structure according to claim 7, wherein said fixed string—encoder fifth position sensor is positioned at the point (0, 1378,0) as the x, y, z coordinates.

18. The three-dimensional position and orientation calculation and robotic application structure according to claim 8, wherein said fixed string—encoder sixth position sensor is positioned at the point (−400, 1378,0) as the x, y, z.

19. The three-dimensional position and orientation calculation and robotic application structure according to claim 1, comprising an orientation board which is located on the portable recording apparatus and supplying power to the inertial measurement unit, reading the values of rolling and inclination angle and communicates with the inertial measurement unit via the Serial Peripheral Interface (SPI) protocol to transmit these readings over the Universal Serial Bus (USB) to the personal computer (PC).
